(19) United States
(12) Patent Application Publication
(10) Pub. No.: US 2018/0177347 A1
(43) Pub. Date: Jun. 28, 2018

(54) Bathing Seat Assembly

(71) Applicant: Jamille Batiste, Houston, TX (US)

(72) Inventor: Jamille Batiste, Houston, TX (US)

(21) Appl. No.: 15/391,288

(22) Filed: Dec. 27, 2016

(51) Int. Cl. A47K 3/12; A47D 1/00; A47D 15/00; A63H 33/00

(52) U.S. Cl. CPC A47K 3/127; A47D 1/004; F16B 47/00; A63H 33/006; A47D 15/006

(57) ABSTRACT

A bathing seat assembly for use in bathing an infant or young child includes a top ring, a bottom ring, a panel and a plurality of posts. The top ring is padded. The panel, which is flexible and meshed, is coupled to and extends from the top ring. A pair of holes, positioned through the panel, are configured to insert the legs of a user, such as an infant or young child. The posts are coupled to and extend between the top ring and the bottom ring. Each post comprises a plurality of nested sections, rendering the posts extendable and the user variably positionable relative to the bottom ring. A plurality of couplers is coupled the bottom ring. The couplers are configured to reversibly couple the bottom ring to surfaces, such as a bathtub and a shower enclosure. A toy, which is water resistant, is coupled to the top ring.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to seat assemblies and more particularly pertains to a new seat assembly for use in bathing an infant or young child.

### BRIEF SUMMARY OF THE INVENTION

An embodiment of the disclosure meets the needs presented above by generally comprising a top ring, a bottom ring, a panel and a plurality of posts. The top ring is padded. The panel, which is flexible and meshed, is coupled to and extends from the top ring. A pair of holes, positioned through the panel, are configured to insert the legs of a user, such as an infant or young child. The posts are coupled to and extend between the top ring and the bottom ring. Each post comprises a plurality of nested sections, rendering the posts extendable and the user variably positionable relative to the bottom ring. A plurality of couplers is coupled the bottom ring. The couplers are configured to reversibly couple the bottom ring to surfaces, such as a bathtub and a shower enclosure. A toy, which is water resistant, is coupled to the top ring.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a bathing seat assembly according to an embodiment of the disclosure.

FIG. 2 is a bottom view of an embodiment of the disclosure.

FIG. 3 is a top view of an embodiment of the disclosure.

FIG. 4 is a front view of an embodiment of the disclosure.

FIG. 5 is a side view of an embodiment of the disclosure.

### DETAILED DESCRIPTION OF THE INVENTION

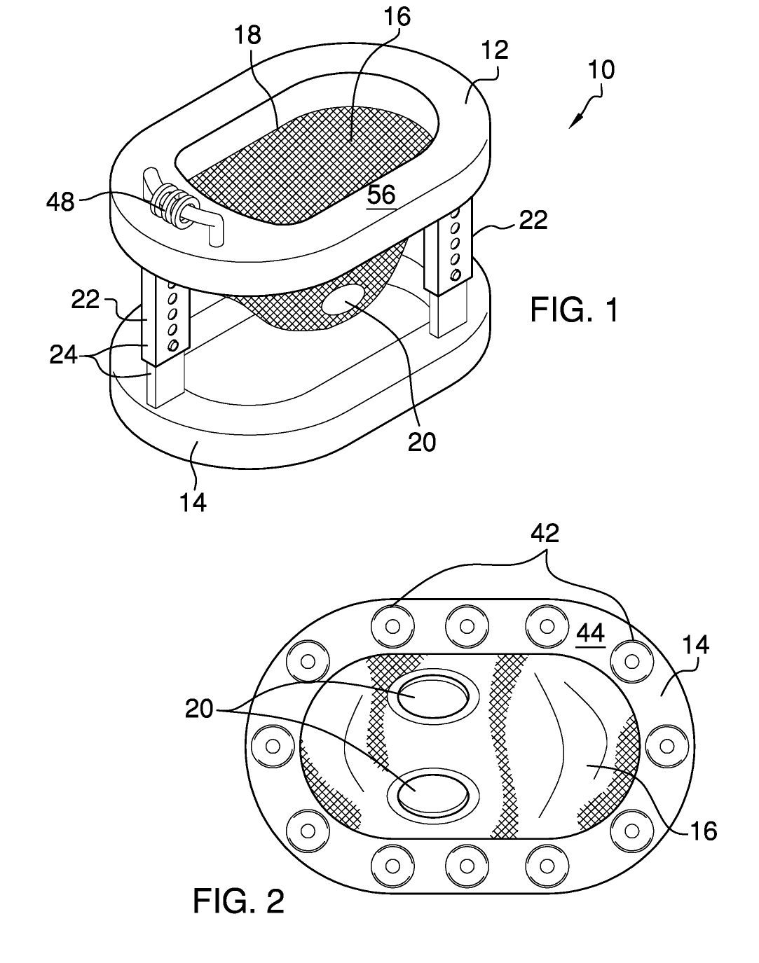

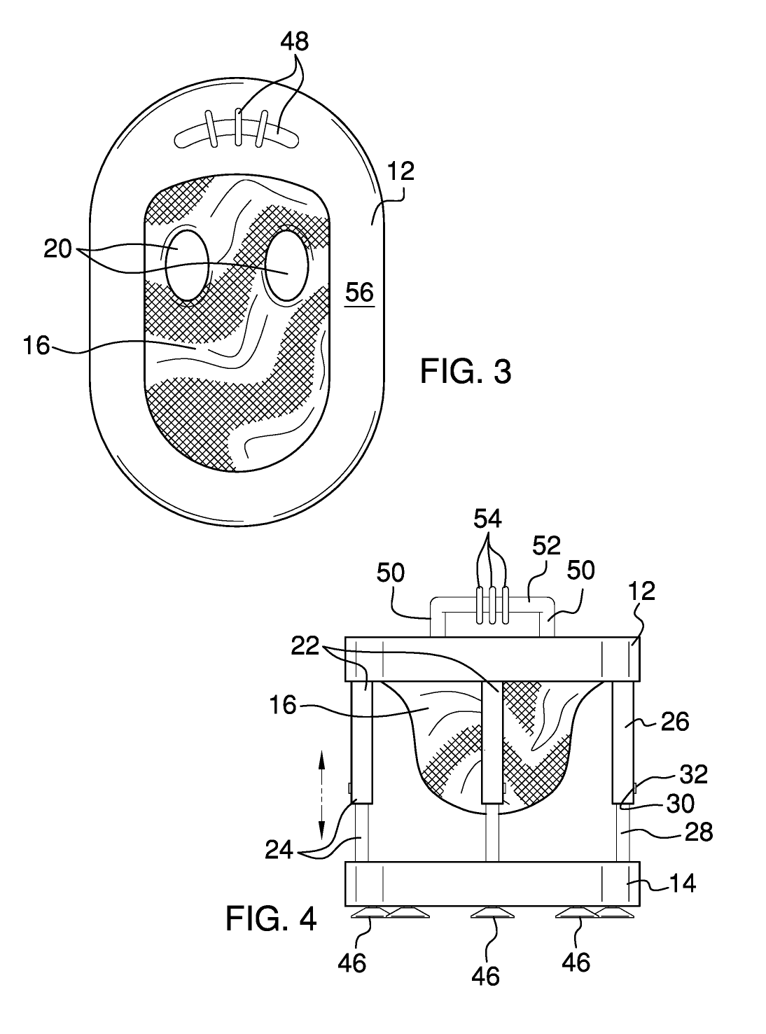

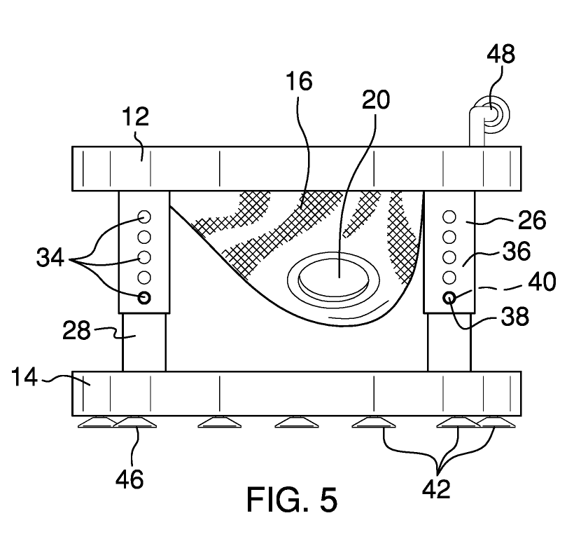

With reference now to the drawings, and in particular to FIGS. 1 through 5 thereof, a new seat assembly embodying the principles and concepts of an embodiment of the disclosure and generally designated by the reference numeral 10 will be described.

As best illustrated in FIGS. 1 through 5, the bathing seat assembly 10 generally comprises a top ring 12 and a bottom ring 14. The top ring 12 is padded. In one embodiment, the top ring 12 is substantially ovally shaped. In another embodiment, the bottom ring 14 is shaped complementarily to the top ring 12.

A panel 16 is coupled to and extends from the top ring 12. The panel 16 is flexible and meshed. In one embodiment, the panel 16 is positioned proximate to an inner perimeter 18 of the top ring 12.

A pair of holes 20 is positioned through the panel 16. Each hole 20 is configured to insert a respective leg of a user, such as an infant or young child. The user is positioned on the panel 16 within the top ring 12.

A plurality of posts 22 is coupled to and extends between the top ring 12 and the bottom ring 14. Each post 22 comprises a plurality of nested sections 24, such that the posts 22 are extendable. The posts 22 are configured to adjustably position the top ring 12 relative to the bottom ring 14. The user who is positioned on the panel 16 within the top ring 12 is variably positionable relative to the bottom ring 14.

In one embodiment, the posts 22 are substantially rectangularly shaped when viewed longitudinally. In another embodiment, the plurality of posts 22 comprises three posts 22. In yet another embodiment, each post 22 comprises an outer segment 26, which is coupled to the top ring 12, and an inner segment 28 that is coupled to the bottom ring 14.

A first connector 30 is coupled to the outer segment 26. A second connector 32 is coupled to the inner segment 28. The second connector 32 is complementary to the first connector 30. The second connector 32 is positioned to selectively couple to the first connector 30 to couple the inner segment 28 to the outer segment 26. The top ring 12 is vertically fixedly positioned relative to the bottom ring 14.

In one embodiment, the first connector 30 comprises a plurality of orifices 34 that is positioned through an outer face 36 of the outer segment 26. In this embodiment, the second connector 32 comprises a pin 38 that is coupled to and positioned in the inner segment 28. The pin 38 is spring-loaded and is selectively extensible through a penetration 40 that is positioned in the inner segment 28. The pin 38 and the penetration 40 are complementary to the orifices 34. The pin 38 is configured to extend through the penetration 40 and a respective orifice 34 to couple the inner segment 28 to the outer segment 26. The pin 38 also is configured to be depressed to decouple the inner segment 28 from the outer segment 26.

A plurality of couplers 42 is coupled to a lower face 44 of the bottom ring 14. The couplers 42 are configured to reversibly couple the bottom ring 14 to surfaces, such as a bathtub and a shower enclosure. In one embodiment, the plurality of couplers 42 comprises twelve couplers 42. In another embodiment, each coupler 42 comprises a suction cup 46.

A toy 48 is coupled to the top ring 12. The toy 48 is water resistant. The toy 48 is configured to entertain the user who is positioned on the panel 16 within the top ring 12. In one embodiment, the toy 48 comprises a pair of first bars 50, a second bar 52 and a plurality of loops 54. The pair of first bars 50 is coupled to and extends substantially perpendicularly from an upper surface 56 of the top ring 12. The second bar 52 is coupled to and extends between the first bars 50 distal from the top ring 12. The loops 54 are positioned around the first bars 50 and the second bar 52. The loops 54 are configured to be repositioned by the user who is positioned on the panel 16 within the top ring 12 to entertain the user.

In use, the holes 20 are positioned through the panel 16 such that each hole 20 is configured to insert the respective leg of the user. The user is positioned on the panel 16 within the top ring 12. The posts 22 are positioned on the top ring 12 and the bottom ring 14 and are configured to adjustably position the top ring 12 relative to the bottom ring 14. The user who is positioned on the panel 16 within the top ring 12 is variably positionable relative to the bottom ring 14. The couplers 42 are configured to reversibly couple the bottom ring 14 to the surfaces. The loops 54 are positioned on the first bars 50 and the second bar 52 and are configured to be repositioned by the user to entertain the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A bathing seat assembly comprising:
a top ring, said top ring being padded, said top ring having a pair of straight longitudinal side sections and a pair of arcuate end sections coupled to and extending between said longitudinal side sections;
a bottom ring;
a panel coupled to and extending from said top ring, said panel being flexible, said panel being meshed;
a pair of holes positioned through said panel, wherein said holes are positioned through said panel such that each said hole is configured for inserting a respective leg of a user such that the user is positioned on said panel within said top ring;
a plurality of posts coupled to and extending between said top ring and said bottom ring, each said post comprising a plurality of nested sections such that said posts are extendable, wherein said posts are positioned on said top ring and said bottom ring such that said posts are configured for adjustably positioning said top ring relative to said bottom ring such that the user positioned on said panel within said top ring is variably positionable relative to said bottom ring, one of said posts being positioned at a middle of one of said arcuate end sections of said top ring;
a plurality of couplers coupled to a lower face of said bottom ring, said couplers being configured for reversibly coupling said bottom ring to surfaces wherein said couplers are positioned on said bottom ring such that said couplers are configured for reversibly coupling said bottom ring to the surfaces; and
a toy coupled to said top ring, said toy being positioned vertically aligned with said one of said posts coupled to said middle of said arcuate end sections of said top ring wherein each of said pair of holes is rearwardly spaced from and laterally spaced to a respective side of said one of said posts coupled to said middle of said arcuate end sections of said top ring, said toy being water resistant, wherein said toy is positioned on said top ring such that said toy is configured for entertaining the user positioned on said panel within said top ring.

2. The assembly of claim 1, further including said top ring being substantially ovally shaped, said bottom ring being shaped complementarily to said top ring.

3. The assembly of claim 1, further including said panel being positioned proximate to an inner perimeter of said top ring.

4. The assembly of claim 1, further including said posts being substantially rectangularly shaped when viewed longitudinally.

5. The assembly of claim 1, further including said plurality of posts comprising three said posts.

6. The assembly of claim 1, further including each said post comprising an outer segment coupled to said top ring and an inner segment coupled to said bottom ring.

7. The assembly of claim 6, further comprising:
a first connector coupled to said outer segment;
a second connector coupled to said inner segment, said second connector being complementary to said first connector, and
wherein said second connector is positioned on said inner segment such that said second connector is positioned for selectively coupling to said first connector to couple said inner segment to said outer segment such that said top ring is vertically fixedly positioned relative to said bottom ring.

8. The assembly of claim 7, further comprising:
said first connector comprising a plurality of orifices positioned through an outer face of said outer segment;
said second connector comprising a pin coupled to and positioned in said inner segment, said pin being spring-loaded, said pin being selectively extensible through a penetration positioned in said inner segment, said pin and said penetration being complementary to said orifices; and
wherein said pin is positioned in said inner segment such that said pin is configured for extending through said penetration and a respective said orifice to couple said inner segment to said outer segment, and wherein said pin is configured for depressing for decoupling said inner segment from said outer segment.

9. The assembly of claim 1, further including said plurality of couplers comprising twelve said couplers.

10. The assembly of claim 1, further including each said coupler comprising a suction cup.

11. The assembly of claim 1, further including said toy comprising:
a pair of first bars coupled to and extending substantially perpendicularly from an upper surface of said top ring;
a second bar coupled to and extending between said first bars distal from said top ring;
a plurality of loops positioned around said first bars and said second bar; and
wherein said loops are positioned on said first bars and said second bar such that said loops are configured for repositioning by the user positioned on said panel within said top ring.

12. A bathing seat assembly comprising:
a top ring, said top ring being padded, said top ring being substantially ovally shaped, said top ring having a pair of straight longitudinal side sections and a pair of arcuate end sections coupled to and extending between said longitudinal side sections;
a bottom ring, said bottom ring being shaped complementarily to said top ring;
a panel coupled to and extending from said top ring, said panel being flexible, said panel being meshed, said panel being positioned proximate to an inner perimeter of said top ring;
a pair of holes positioned through said panel, wherein said holes are positioned through said panel such that each said hole is configured for inserting a respective leg of a user such that the user is positioned on said panel within said top ring;
a plurality of posts coupled to and extending between said top ring and said bottom ring, one of said posts being positioned at a middle of one of said arcuate end sections of said top ring, each said post comprising a plurality of nested sections such that said posts are extendable, wherein said posts are positioned on said top ring and said bottom ring such that said posts are configured for adjustably positioning said top ring relative to said bottom ring such that the user positioned on said panel within said top ring is variably positionable relative to said bottom ring, said posts being substantially rectangularly shaped when viewed longitudinally, said plurality of posts comprising three said posts, each said post comprising:
an outer segment coupled to said top ring,
an inner segment coupled to said bottom ring,
a first connector coupled to said outer segment, said first connector comprising a plurality of orifices positioned through an outer face of said outer segment, and
a second connector coupled to said inner segment, said second connector being complementary to said first connector, wherein said second connector is positioned on said inner segment such that said second connector is positioned for selectively coupling to said first connector to couple said inner segment to said outer segment such that said top ring is vertically fixedly positioned relative to said bottom ring, said second connector comprising a pin coupled to and positioned in said inner segment, said pin being spring-loaded, said pin being selectively extensible through a penetration positioned in said inner segment, said pin and said penetration being complementary to said orifices, wherein said pin is positioned in said inner segment such that said pin is configured for extending through said penetration and a respective said orifice to couple said inner segment to said outer segment, and wherein said pin is configured for depressing for decoupling said inner segment from said outer segment;
a plurality of couplers coupled to a lower face of said bottom ring, said couplers being configured for reversibly coupling said bottom ring to surfaces wherein said couplers are positioned on said bottom ring such that said couplers are configured for reversibly coupling said bottom ring to the surfaces, said plurality of couplers comprising twelve said couplers, each said coupler comprising a suction cup;
a toy coupled to said top ring, said toy being positioned vertically aligned with said one of said posts coupled to said middle of said arcuate end sections of said top ring wherein each of said pair of holes is rearwardly spaced from and laterally spaced to a respective side of said one of said posts coupled to said middle of said arcuate end sections of said top ring, said toy being water resistant, wherein said toy is positioned on said top ring such that said toy is configured for entertaining the user positioned on said panel within said top ring, said toy comprising:
a pair of first bars coupled to and extending substantially perpendicularly from an upper surface of said top ring,
a second bar coupled to and extending between said first bars distal from said top ring,
a plurality of loops positioned around said first bars and said second bar, and
wherein said loops are positioned on said first bars and said second bar such that said loops are configured for repositioning by the user positioned on said panel within said top ring; and
wherein said holes are positioned through said panel such that each said hole is configured for inserting the respective leg of the user such that the user is positioned on said panel within said top ring, wherein said posts are positioned on said top ring and said bottom ring such that said posts are configured for adjustably positioning said top ring relative to said bottom ring such that the user positioned on said panel within said top ring is variably positionable relative to said bottom ring, wherein said couplers are positioned on said bottom ring such that said couplers are configured for reversibly coupling said bottom ring to the surfaces, wherein said loops are positioned on said first bars and said second bar such that said loops are configured for repositioning by the user positioned on said panel within said top ring.
